(19) United States
(12) Patent Application Publication
(10) Pub. No.: US 2020/0343822 A1
(43) Pub. Date: Oct. 29, 2020

(54) POWER CABLE DEVICE

(71) Applicant: Matthew Robert Nagy, Lumby (CA)

(72) Inventor: Matthew Robert Nagy, Lumby (CA)

(21) Appl. No.: 16/393,939

(22) Filed: Apr. 24, 2019

(51) Int. Cl. H02M 7/00; H02M 7/04; B60L 53/18

(52) U.S. Cl. CPC H02M 7/003; B60L 2210/30; B60L 53/18; H02M 7/043

(57) ABSTRACT

A power cable device to supply electrical power from an alternative current (AC) source to a direct current (DC) vehicle battery having positive and negative terminals The device includes a first cable segment having an AC-DC converter configured to convert AC line voltage to DC voltage required to operate a vehicle battery, An AC input cord is configured to convey AC power from an AC source to the AC-DC converter. The AC input cord has an AC cord first end and an AC cord second end. The AC cord first end has an AC plug configured to engage with the AC power source. The AC cord second end is in electrical communication with the AC-DC converter. A first DC cord is configured to convey DC power from the AC-DC converter to a first coupling. The first DC cord has a first DC cord first end and a first DC cord second end. The first DC cord first end is in electrical communication with the AC-DC converter. The first DC cord second end has the first coupling attached thereon. A second cable segment has a second DC cord configured to convey DC power from a second coupling to a DC battery end. The second DC cord has a second DC cord first end and a second DC cord second end. The second DC cord first end has the second coupling attached thereon. The second DC cord second end has a positive engagement end and a negative engagement end configured to engage the positive and negative terminals of the vehicle battery. The first and second couplings are adapted to be physically and electrically coupled and uncoupled to permit the selective electrical connection between the first DC cord and the second DC cord.

### REFERENCE TO PENDING APPLICATIONS

This application does not claim the benefit of any issued U.S. patent or pending application.

### TECHNICAL FIELD

The present invention is generally directed toward power cable, and specifically, toward a power cable configured to convert alternating current (AC) into direct current (DC) and provide the DC current to a vehicle battery.

### BACKGROUND

Power cables, jumper or booster cables have long been used to provide a vehicle battery to operate when it has lost its charge. Typically, the use of a direct current (DC) battery is required to charge or jump a vehicle battery due to the vehicle battery being a direct current battery. However, this is problematic in that a DC power source is not always available or practical for use.

Accordingly, there is a need for an apparatus and to address the issues set out above.

### SUMMARY

The present invention is generally directed toward power cable, and specifically, toward a power cable configured to convert alternating current (AC) into direct current (DC) and provide the DC current to a vehicle battery.

In one aspect, a power cable device to supply electrical power from an alternative current (AC) source to a direct current (DC) vehicle battery having positive and negative terminals is disclosed. The device includes a first cable segment and a second cable segment.

The first cable segment has an AC-DC converter that is configured to convert AC line voltage to DC voltage required to operate a vehicle battery. The first cable segment further includes an AC input cord that is configured to convey AC power from an AC source to the AC-DC converter. The AC input cord has an AC cord first end and an AC cord second end. The AC cord first end has an AC plug configured to engage with the AC power source. The AC cord second end is in electrical communication with the AC-DC converter.

The first cable segment further includes a first DC cord that is configured to convey DC power from the AC-DC converter to a first coupling. The first DC cord has a first DC cord first end and a first DC cord second end. The first DC cord first end being is in electrical communication with the AC-DC converter, while the first DC cord second end has the first coupling attached thereon.

The second cable segment has a second DC cord that is configured to convey DC power from a second coupling to DC battery end. The second DC cord has a second DC cord first end and a second DC cord second end. The second DC cord first end has the second coupling attached thereon. The second DC cord second end has a positive engagement end and a negative engagement end that are both configured to engage the positive and negative terminals of the vehicle battery, respectively.

The first and second couplings are adapted to be physically and electrically coupled and uncoupled to permit the selective electrical connection between the first DC cord and the second DC cord. This can allow for the second cable segment to remain attached the vehicle battery when not in use, while being available for use as the need arises.

In some aspects, the AC-DC converter comprises at least one electrical transformer, at least one rectifier and at least one filter. The term rectifier means an electrical device that converts alternating current (AC), which periodically reverses direction, to direct current (DC), which flows in only one direction.

In some aspects, the AC source is a 110 Volts power outlet, such as those typically utilized in residential homes. In such aspects, the AC plug is a two or three prong configured plug that is capable of engaging the 110 Volts power outlet. The ability to use a 110 Volt power outlet to provide power to a vehicle battery, such as a 12 Volt automobile battery, provides for the efficient and effective charging of the battery at a person's home.

In some aspects, visual notifications, such as an LED light, may be included to visually provide the status of the device. One such visual notification may be when the AC-DC converter is in operation.

In some aspects, the engagement ends of the second cable segment include tension clamps. The use of a clamp can allow for quick attachment and detachment of the device from the battery. In other aspects, the engagement ends may include hard wire loops, or terminal rings, which are designed to be place over and around the terminals in a more long term attachment configuration. The use of a terminal ring, or other similar type of connector, allows for the second cable segment to be attached to the battery and under the hood of the vehicle when not in use.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a block diagram of an embodiment of present invention.

FIG. 2 is a schematic diagram of an embodiment of the present invention.

FIG. 3 is a schematic diagram of an additional embodiment of the present invention.

### DETAILED DESCRIPTION OF THE INVENTION

The present invention is directed to an apparatus that is configured to convert alternating current (AC) into direct current (DC) and provide the DC current to a vehicle battery. In general, the apparatus includes two cable segments. The first cable segment generally includes an AC to DC converter circuit and is configured to receive AC power from an AC power source. Further, this cable segment is configured to remain outside of the vehicle. The second cable is connected to the vehicle's battery and is configured to remain inside the engine compartment when in use as well as when not in use. When in use, the two cable segments are connected by connectors located on both cable segments.

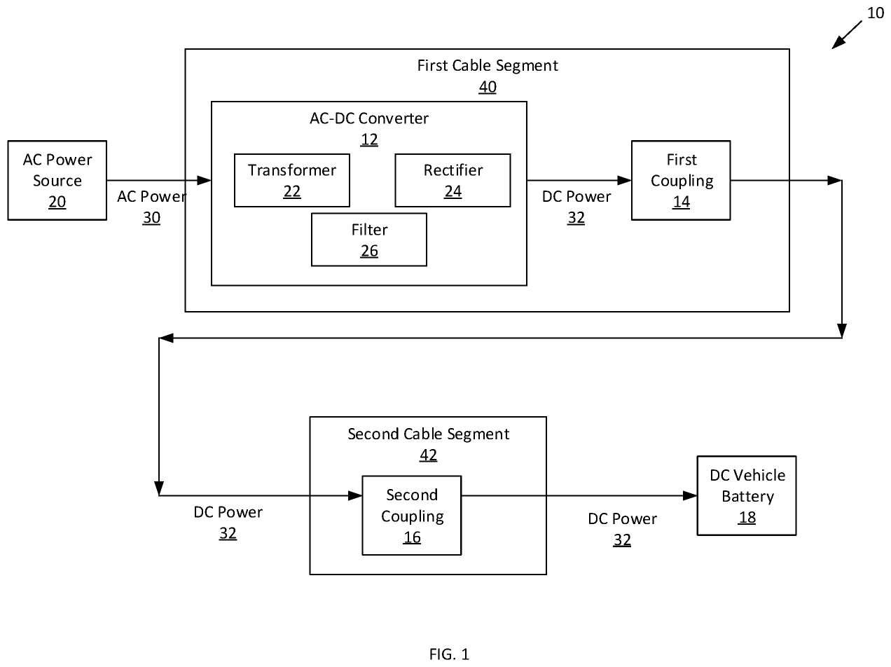

As illustrated in FIG. 1, a block diagram view of an embodiment of the power cable device of the present invention is indicated generally at 10. Device 10 is configured to receive AC power 30 from an AC power source 20, such as a standard 110 V household power outlet and converts the AC power 30 into DC power 32. DC power 32 is then provided to a DC vehicle battery 18.

Device 10 includes first cable segment 40 and a second cable segment 42. Segments 40 and 42 are connected by a first and second coupling 14, 16. Couplings 14 and 16 may be any standard coupling that is configured to allow electrical connection from the AC power source 20 through to the DC vehicle battery 18. In some embodiments, couplings 14, 16 may be male/female plugs, quick connect couplings or other suitable connectors that allows for the transfer of electric current between the first cable segment 40 and the second cable segment 42.

The AC to DC power converter module 12 is configured to convert AC power to DC, and a power cable 22 extending from to the converter unit for carrying the converted DC power to a plug 24, which is constructed and adapted to be plugged into the housing 16 of the battery pack module 12. In this embodiment, module 12 includes an electrical transformer 22, a rectifier 24 and a filter 26. This is illustrative and not meant to be limiting. Those skilled in the art will recognize that other configurations having other electronic components that are capable of converting alternative current to direct current may be included within module 12 and be within the scope of the present invention.

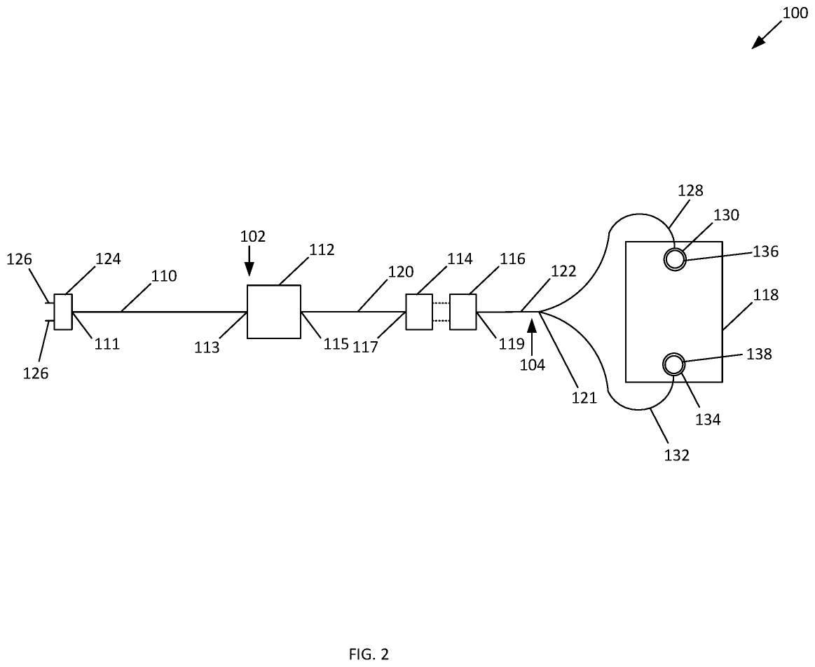

As illustrated in FIG. 2, a schematic view of an embodiment of the power cable device of the present invention is indicated generally at 100. Device 100 includes first cable segment 102 and a second cable segment 104.

First cable segment 102 has an AC input cord 110 has an AC cord first end 111 and an AC cord second end 113. The AC cord first end 111 has an AC plug 124 having prongs 126 that are configured to engage with the AC power source. AC cord second end 113 is in electrical communication with an AC-DC converter 112. AC input cord 110 is configured to convey AC power from an AC source to the AC-DC converter 112. The AC-DC converter 112 is configured to convert AC line voltage to DC voltage required to operate a vehicle battery 118.

In some embodiments, AC-DC converter 112 may include at least one rectifier and at least one filter. The conversion of alternating current into direct current is called rectification. A rectifier circuit utilizes a series of diodes to even AC power out into DC power, or a sort of “pulsating DC.” The at least one rectifier may be a half-wave rectifier that utilizes a single diode, a full-wave rectifier that utilizes two diodes or bridge rectifier that utilized four diodes. Those skilled in the art will recognize that additional rectifier configurations may be utilized and are within the scope of the present invention.

As the rectifier converts the alternating current to direct current, the resulting direct current is often not a steady voltage. As such, the at least one filter performs the task of flattening out any ripple or pulsating current.

Those skilled in the art will recognize that other electrical components, such as at least one transformer and at least one capacitor, may also be include within AC-DC converter 112. The at least one transformer's purpose is to transmit and convert a high voltage to a lower voltage suitable for AC to DC conversion by the rectifier. The at least one capacitors purpose is to provide a smoother DC current as the rippled DC current passes through.

In some embodiments, AC-DC converter 112 may include hardware and electrical components, such as an LED light, to provide visual notifications of the status of the device. One such visual notification may be when the AC-DC converter is in operation. Further, some embodiments may include electrical and hardware components, such a selector switch, to allow for multiple output voltage settings to allow for differing levels of output voltage to be provided by the AC-DC converter 112. The different levels may be configured for the desired needs of the user, such as when a battery is in need of a jump start.

Referring back to FIG. 2, first cable segment 102 also has a first DC cord 120 having a first DC cord first end 115 and a first DC cord second end 117. The first DC cord first end 115 is in electrical communication with the AC-DC converter 112. The first DC cord second end 117 has a first coupling 114 attached thereon. First DC cord 120 is configured to convey DC power from the AC-DC converter 112 to the first coupling 114.

Second cable segment 104 has a second DC cord 122 having a second DC cord first end 119 and a second DC cord second end 121. The second DC cord first 119 end has a second coupling 116 attached thereon. The second DC cord 122 is configured to convey DC power from a second coupling to DC battery end. The first and second couplings 114, 116 are adapted to be physically and electrically coupled and uncoupled to permit an electrical connection between the first DC cord 120 and the second DC cord 122. The first and second coupling 114, 116 may be any coupling that allows for the transfer of electric current, such as but not limited to a standard male/female electric plug set.

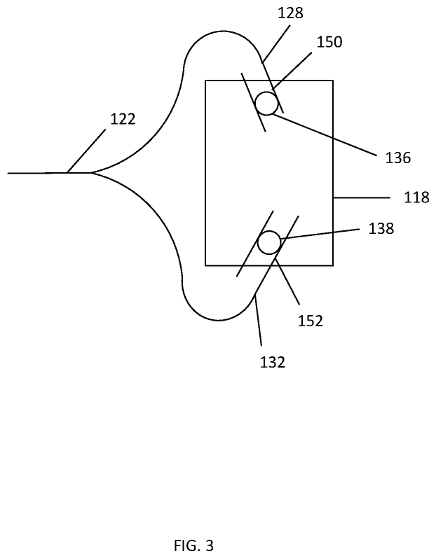

The second DC cord second end 121 of the second DC cord 122 has a positive engagement end 128 and a negative engagement end 132 which are configured to engage the positive and negative terminals 136, 138 of the vehicle battery 118. In this embodiment, the engagement ends 128, 132 include hard wire loops 130, 134, or terminal rings, which are designed to be place over and around the terminals in a more long-term attachment configuration. The use of loops 130, 134 allow for the second DC cord 122 to be attached to the battery 112 and under the hood of the vehicle when not in use. In this embodiment, engagement ends are illustrated as circular connectors 130, 134 that sit around and engage the respective positive and negative terminals 136, 138 of battery 118. This is illustrative and is not meant to be limiting. By way of example, as shown in FIG. 3, clamp, or tension, connectors 150, 152 are shown to engage positive and negative terminals 136, 138 of battery 118.

In operation, the first cable segment may be plugged into a standard 110 Volt wall outlet. The second cable segment may be secured to an automobile battery via the ring connectors. The second cable segment may be secured within the vehicle's engine compartment by any suitable fastener, such a look and hook fastener. When the need arises to charge the automobile battery, the operator may simply connect the first cable segment to a standard wall outlet and then connect the two cable segments together by connecting the first and second and second couplings. AC electrical power will then be able to travel from the wall outlet through the first cable segment when it is converted into DC power by the AC-DC converter. The DC power will then be able to travel through the remaining portion of the first cable segment and the second cable segment where it will provide a charge to the target automobile 12 Volt DC battery.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A power cable device to supply electrical power from an alternative current (AC) source to a direct current (DC) vehicle battery, the vehicle battery having positive and negative terminals, comprising,
a first cable segment having
an AC-DC converter configured to convert AC line voltage to DC voltage required to operate a vehicle battery,
an AC input cord being configured to convey AC power from an AC source to the AC-DC converter, the AC input cord having an AC cord first end and an AC cord second end, the AC cord first end having an AC plug configured to engage with the AC power source, the AC cord second end being in electrical communication with the AC-DC converter, and
a first DC cord being configured to convey DC power from the AC-DC converter to a first coupling, the first DC cord having a first DC cord first end and a first DC cord second end, the first DC cord first end being in electrical communication with the AC-DC converter, the first DC cord second end having the first coupling attached thereon; and
a second cable segment having
a second DC cord being configured to convey DC power from a second coupling to DC battery end, the second DC cord having a second DC cord first end and a second DC cord second end, the second DC cord first end having the second coupling attached thereon, the second DC cord second end having a positive engagement end and a negative engagement end configured to engage the positive and negative terminals of the vehicle battery,
the first and second couplings adapted to be physically and electrically coupled and uncoupled to permit the selective electrical connection between the first DC cord and the second DC cord.

2. The power cable device of claim 1, wherein the AC-DC converter comprises at least one electrical transformer, at least one rectifier and at least one filter.

3. The power cable device of claim 1, wherein the AC source is a 110 Volts power outlet, and wherein the AC plug further comprises at least two prongs configured to engage the 110 Volts power outlet.

4. The power cable device of claim 1, wherein the vehicle battery is a 12 Volts vehicle battery.

5. The power cable device of claim 1, wherein the AC-DC converter further comprises at least one light indicator configured to illuminate when in operation.

6. The power cable device of claim 1, wherein the positive engagement end and a negative engagement end are further defined as having a positive clamp and a negative clamp configured to engage the positive and negative terminals of the vehicle battery.
